(19) United States
(12) Patent Application Publication
(10) Pub. No.: US 2006/0012331 A1
(43) Pub. Date: Jan. 19, 2006

(54) Storage case with power and charging system

(76) Inventor: William J. Gillette II, Fort Collins, CO (US)

Correspondence Address: SQUIRE, SANDERS & DEMPSEY L.L.P.;Two Renaissance Square, Suite 2700, 40 North Central Avenue, Phoenix, AZ, 85004-4498, US

(21) Appl. No.: 11/113,345

(22) Filed: Apr. 21, 2005

Related U.S. Application Data
(60) Provisional application No. 60/564,442, filed on Apr. 21, 2004.

(51) Int. Cl. H02J 7/00

(52) U.S. Cl. 320/107

(57) ABSTRACT

A case for retaining one or more electronic devices includes electronic circuitry integral with the case. The circuitry is connectable to a power source and is connectable to at least one of the one or more electronic devices in order to provide electric power thereto. The power source may be a photovoltaic module and the module may be attached to or integral with the case. If a photovoltaic module is used it may be expandable to provide more surface area than the area of any side of the case. The case may also include, among other things, an integral power source, such as a DC battery, that could be connected to one or more electronic devices.

### CROSS-REFERENCE TO RELATED APPLICATIONS

This application claims benefit of priority under 35 U.S.C. § 119 to U.S. Provisional Patent Application Ser. No. 60/564,442, filed Apr. 21, 2004 by William J. Gillette II the contents of which are incorporated herein in its entirety.

### FIELD OF THE INVENTION

The invention relates to cases, packages, bags, luggage or any apparatus (collectively, “cases” and singly “case”) in or to which one or more electronic devices can be positioned or retained (collectively, “retained”). A case according to the invention includes electronic circuitry connectable to at least one of the electronic devices.

### BACKGROUND

Portable electronic devices are known, as are cases for retaining or holding portable electronic devices. Electronic devices require electrical power to operate and receive electrical power from a power source such as a DC battery or an electrical outlet. Known cases function to conveniently and safely carry portable electronic devices, but the cases do not have the ability to supply power to an electronic device, either while the device is in the case or out of it. The device and its power cord are usually retained in the case and removed and assembled to power or charge (collectively, “power”) the electronic device.

It would be beneficial to provide a case that could supply power to an electronic device. The case could include a power source, such as a DC battery, and/or a system such as a photovoltaic module. In this manner an electronic device could be charged while retained or held in the case, or could be operated by power generated by the case.

### SUMMARY OF THE INVENTION

The invention is a case for retaining one or more electronic devices, wherein the case includes integral electronic circuitry. As used herein with respect to circuitry or a power source (such as a battery and/or a photovoltaic module) being integral with the case, integral means permanently attached to the case, or specifically configured to be retained in the case and to function while being at least partially retained therein. The circuitry includes an electric cord that is connectable to a power source and is connectable to at least one of the electronic devices in order to provide power to the electronic device.

The power source may be a standard AC outlet, in which case the cord would extend outside of the case, preferably through a special opening in the case, to access the outlet. The power source may be or include a DC battery integral with the case, the battery being any suitable size and configuration, such batteries being known to those skilled in the art.

The power source may also be or include a photovoltaic module integral with the case. The photovoltaic module is preferably permanently positioned on an exterior surface of the case or is configured to be positioned in a compartment of the case that is designed to receive the module.

### BRIEF DESCRIPTION OF THE DRAWINGS

FIG. 1 is a front, perspective view of a case that may be used with the invention.

FIG. 2 shows the case of FIG. 1 with a computer being removed therefrom.

FIG. 3 shows the case of FIG. 1 open to expose a photovoltaic module.

FIG. 4 shows the case of FIG. 1 wherein the photovoltaic module has multiple, foldable panels to increase the surface area for gathering light energy.

### DETAILED DESCRIPTION OF PREFERRED EMBODIMENTS

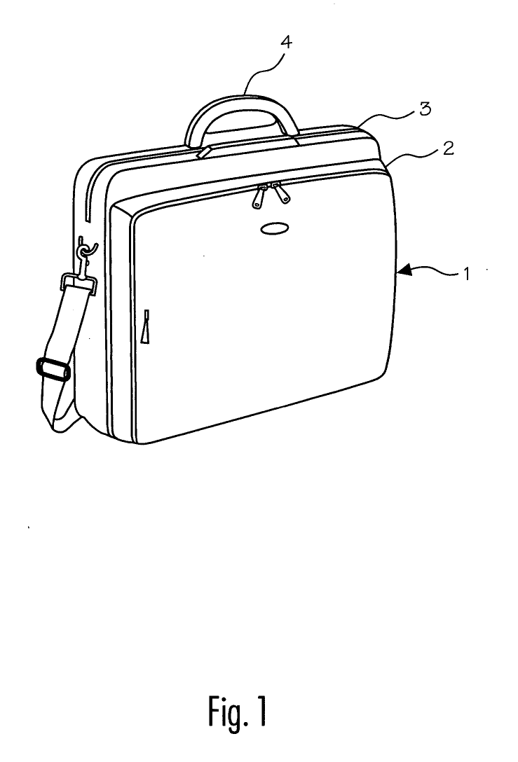

The technology associated with this invention includes two existing, known technologies: (1) a power source, such as power generated by photovoltaic technology, and (2) cases for portable, electronic devices. Turning now to the Figures, where the purpose is to describe a preferred embodiment of the invention and not to limit same, FIG. 1 shows a case 1 in accordance with the invention. As shown, case 1 is a soft-sided, lap-top computer case having a handle 2, compartment 3 for retaining at least part of the power source and a compartment 4 for retaining an electronic device, which in this case is a computer.

The invention could utilize any type of case that can retain an electronic device. The case could be a soft-sided or hard-sided suitcase, handbag, computer case, camera bag, messenger bag, backpack, briefcase, computer case or bag, CD player case, cell phone case, mobile phone case, satellite phone, MP3 music player case, GPS case, and/or a PDA case as well as hybrid hard/soft-sided cases. Flexible soft-sided conformable cases are preferred for use with the invention. These cases are lightweight and can be designed to provide ample padding and protection while transporting or storing electronic products. The addition of pockets, flaps, or compartments, facilitates greater functionality and provides user benefits and convenience. Generally, soft-sided cases are made from leather and/or polymeric materials such as nylon or polyethylene. The ease of fabrication also facilitates the integration of rigid components, such as injection-molded parts or panels, in combination with flexible fabrics.

Hybrid cases utilize both rigid and soft-sided, flexible components. For instance, a hybrid case might have a hard or rigid bottom half with soft sides. This construction would facilitate a design that provides more robustness and abuse tolerance than a comparable design that was constructed entirely of flexible materials. The invention can utilize a hybrid construction case, a rigid, hard-sided case, or a flexible, soft-sided case.

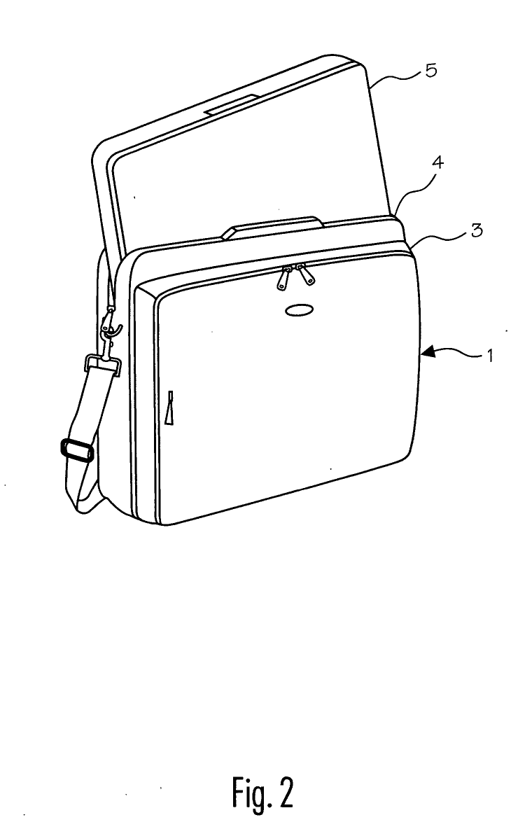

FIG. 2 shows case 1 with compartment 4 open and a computer 5 being removed. As used herein, “electronic device” means any device or system that uses electrical power. While the electronic device in this illustration is computer 5 (computer 5 may be any known portable computer that can be operated by electrical power), the electronic device could be one or more of a computer, camera, video camera, a PDA, a global positioning system (GPS) device, portable music player device (such as a CD player or MP3 player) and/or a cell phone. The invention could also be used with one or more medical, marine, military or industrial devices that are transportable and electrically powered.

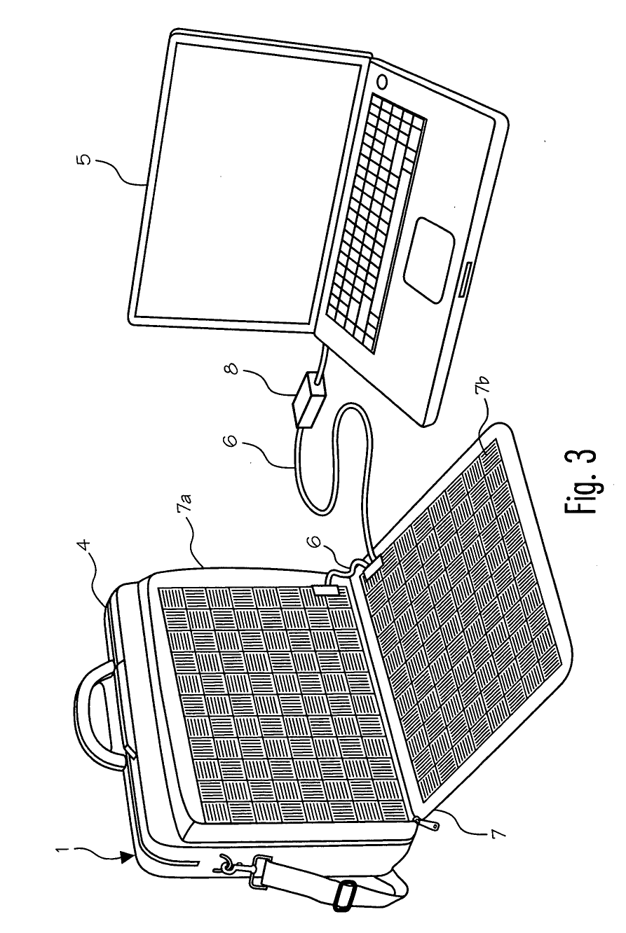

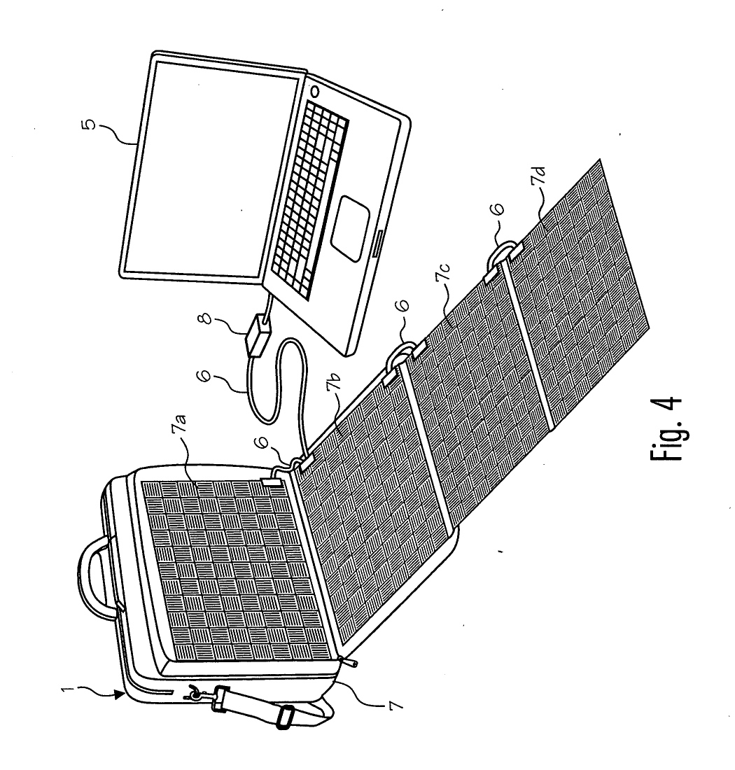

The invention may include a solar energy collector and power generator, such as a photovoltaic module 7, integral with case 1. The photovoltaic solar panel could be of either a rigid (utilizing glass or rigid plastic) or flexible (utilizing flexible plastic) construction. The solar panel and related electronic circuitry could be either integrated or incorporated as an accessory to the electronic equipment case. A flexible, thin film solar panel could be used both to solar recharge and direct power products. As shown in FIGS. 3 and 4 circuitry 6 comprises an electric cord 6a and a voltage regulator 6b. Not shown is an optional DC battery, a plug, a receptacle for receiving a plug that connects to computer 5 or the circuitry of photovoltaic module 7.

As shown in FIGS. 3 and 4 the invention preferably (but not necessarily) includes a photovoltaic module 7. Module 7 as shown is configured to be positioned in its own compartment 3 of case 1. In this example, compartment 3 is also configured to receive and retain module 7. Module 7 is preferably flexible and may roll or fold out to create more surface area to gather solar energy and thus generate more electrical power. As shown in FIG. 4, module 7 has four fold out panels, 7a, 7b, 7c and 7d.

The structure and technology of photovoltaic modules are known to those skilled in the art, but shall be generally described herein. A preferred photovoltaic module is a flexible photovoltaic module. Flexible photovoltaic modules are based upon amorphous silicon technology applied to a durable polymer substrate approximately 2 mils (0.05 mm) thick using a roll-to-roll manufacturing process. Finished modules may be encapsulated in a variety of polymeric materials, each of which is selected to be appropriate for the environment in which the module is used. Thin film flexible photovoltaic modules have been commercialized and examples of which that may be used to practice the invention are BRUNTON SOLARROLL14 (Riverton, Wyo.), and Iowa Thin Film Technologies, Inc. POWERFILM (Ames, Iowa).

Both the POWERFILM and the BRUNTON SOLARROLL14 circuitry are fabricated on a thin film of thermoplastic material and laminated between additional clear layers of thermoplastic film, which helps to provide for a waterproof construction. This method of fabrication allows for a photovoltaic module to be custom sized for a particular application. For instance, in the case of a small digital camera case, the size of the case is small, perhaps 4″ wide×6″ long×3″ deep. By incorporating a flexible solar panel that is capable of folding or rolling up and is integral to the case construction, the photovoltaic module could be sized to deliver the required power (wattage) as well as charging rate (milliamp-hour), while at the same time being incorporated near or in the case. In this example, the case must be larger than a case that would house just the phone.

Another example of a custom-sized photovoltaic module would be one for a lap top computer case. The photovoltaic module could be designed and fabricated to serve as one of the external surfaces of the case—i.e., a large, relatively flat side panel, or both side panels, of the case. If a flexible photovoltaic module is utilized, the thermoplastic lamination that encompasses the solar panel could be sewn (or otherwise affixed) to a soft-sided case such as one manufactured from leather or cloth. Photovoltaic module 7, when exposed to light, would generate power that could be stored in a battery internal or external to the case, or even directly power an electronic device if the voltage and amperage were adequate.

Crystalline silicon was the original material technology used by the PV industry and may be used to practice the invention, although the cost of crystalline PV modules is still relatively high because of material costs and the numerous processing steps needed to manufacture the modules. Crystalline silicon solar modules tend to be bulky, break easily, and expensive.

Another thin-film technology for producing solar cells contains cadmium, and photovoltaic cells utilizing this technology may be used to practice the invention.

Photovoltaic modules using thin-film, vapor-deposited amorphous silicon (a-Si) alloy materials, are preferred, and these are used in the previously-described POWERFILM products. Because a-Si absorbs light more efficiently than its crystalline counterpart, the a-Si solar cell thickness can be 100 times less, thereby significantly reducing material costs. By utilizing a flexible, stainless steel substrate and polymer-based encapsulates, photovoltaic modules utilizing this technology can be very lightweight, flexible and durable.

The POWERFILM photovoltaic modules are based upon amorphous silicon technology applied to a polymer (polyimide) substrate 2 mils (0.05 mm) thick using a true roll-to-roll manufacturing process. Finished modules are encapsulated in a variety of materials appropriate for the application use environment. The general process steps are vacuum deposition (Back Metal, Amorphous Silicon, Transparent Top Contact), printing and laser scribing, bus bar/lead attachment, encapsulation, and die cutting. POWERFILM is patterned on a 13 inch wide web on a roll up to 2400 feet long.

The invention requires an electrical connection between photovoltaic module 7 (if module 7 is included) or a battery (not shown) or other power source and electronic device 5. In the case of a direct power operation wherein photovoltaic module 7 (or other power source(s)) is sized to provide ample wattage to fully operate electronic device 5, module 7 and device 5 would be directly connected with a properly designed cable and plug adapted to connect to device 5, preferably utilizing an existing AC adapter/DC charger plug connection. An option would be to have an integral power bus, or interconnect system, within case 1. Electronic device 5 could then be electrically connected to the integral power bus system.

To accommodate a multitude of different physical plug connection configurations from various manufacturers, an electrical connector integral with case 1 could be of a universal design with a specific end plug design to mate with a specific manufacturer's device. It is intended that the electrical connection between module 7 (or other power source) and electronic device 5 would be DC to DC.

The invention can be configured in many formats. Below are listed several examples of the anticipated potential configurations for the invention.

### EXAMPLE 1

The photovoltaic module is integrally constructed with the case. As an example, one of the sidewalls, or panels, of the case would have a photovoltaic module attached thereto or forming part of the case surface. The photovoltaic module could cover either 100% of the exposed surface area, or a portion of the surface area of the case.

### EXAMPLE 2

The photovoltaic module is integrated into a compartment of the case, as shown in FIGS. 3 and 4. The compartment could be, but is not limited to, a compartment that is secured via a zipper, hook and loop fastener, buckled or alternatively left loose. The photovoltaic cell could simply be positioned in a special compartment and removed when in use or attached or affixed in the compartment, and opened, as shown in FIGS. 3 and 4.

### EXAMPLE 3

The photovoltaic module could be permanently affixed to the case or removable for remote and/or independent operation, separate from the case.

### EXAMPLE 4

The photovoltaic module could be an add-on module sold as an accessory, or upgrade feature to a case.

### EXAMPLE 5

The photovoltaic module could be constructed in a manner that the panels are flat when stored. When in full use, the panel could be unfolded to expand the exposed photovoltaic surface area to more light.

### EXAMPLE 6

The photovoltaic module could be constructed in a manner that rolls up to a diameter convenient for storage in the case/bag. When in use, the photovoltaic would be unrolled, or unfurled to flatten out the panel's surface area, exposing the module's active PV cells for power generation.

### EXAMPLE 7

The photovoltaic module might have a series of hook and loop fasteners, or suction cups to facilitate affixing the module panel during use. These optional attachment devices would facilitate keeping the module panel generally flat and oriented for optimum light collection and power generation.

### EXAMPLE 8

The photovoltaic module can be folded up like an accordion, a zigzag fashion. The number of panels can be tailored to the total surface area required to power the specific device or end application. Example: If a video camera required 9 watts to operate and each photovoltaic panel (sized to fit the camera bag pocket) produced only 1.5 watts, then a zigzag fold out of 6 panels would be required in order to fully operate the video camera. In this configuration, the PV circuit would be interconnected across each of the folding panels.

As mentioned previously, the case may have a battery integral therewith. If a battery is included, the photovoltaic module could be configured as a battery charging system. The case could have integrated within its construction the requisite electronic circuit, voltage regulator, DC to AC transformer and other circuitry for charging the battery via power from the photovoltaic module. The photovoltaic could then charge the battery and the case would serve to operate the electronic device when connected to the battery. The case could also have an interconnect system so the electronic device would plug into the interconnect.

The case might have a photovoltaic module that supports only trickle charging of the electronic device's DC battery. However, by the photovoltaic module could be configured so that additional panels could be added on to provide more power, such as enough to directly operate an electronic device. Example: a standard photovoltaic module configuration might provide 14-watts of power. But in order to run a 28-watt lap top computer, the photovoltaic module could be expanded by adding additional photovoltaic panels to the existing 14 watt module to equal or exceed the minimum 28 watts required.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A case for retaining one or more electronic devices, the case including electronic circuitry integral with the case, the circuitry connectable to a power source and connectable to at least one of the one or more electronic devices.

2. The case of claim 1 wherein the power source is photovoltaic module integral with the case, the photovoltaic module generating power when exposed to solar energy.

3. The case of claim 1 that is selected from the group consisting of a soft-sided case, a rigid case, and a hybrid combination of a soft-sided and rigid case.

4. The case of claim 2 wherein the photovoltaic module is an amorphous thin film photovoltaic module of either rigid or flexible construction.

5. The case of claim 2 wherein the photovoltaic module is selected from the group consisting of: mono-crystalline construction, polycrystalline construction and amorphous construction.

6. The case of claim 2 wherein the photovoltaic module is permanently affixed to the case.

7. The case of claim 2 wherein the photovoltaic module is removable, mountable, or attachable to the case.

8. The case of claim 7 wherein the photovoltaic module is positioned inside the case when not in use.

9. The case of claim 8 wherein the photovoltaic module is positioned in a pocket of the case when not in use, the pocket configured to receive the photovoltaic module.

10. A case for retaining one or more electronic devices, the case including an integral DC battery and circuitry, the circuitry for connecting the DC battery to at least one of the one or more electronic devices and thereby transferring electrical power from the battery to the at least one electronic device.

11. The case of claim 10 wherein at least one electronic device that cannot be retained by the case can be powered.

12. The case of claim 10 wherein the circuitry also can connect the DC battery to a power source in order to charge the battery.

13. The case of claim 2 wherein the photovoltaic module includes a plurality of panels including an initial module connected directly to the electronic circuitry, and one or more additional modules to add more power, increase the voltage or increase the amperage.

14. The case of claim 1 wherein the electronic circuitry includes an integrated connection system for at least one of the one or more electronic devices.

15. The case of claim 2 wherein the photovoltaic module forms part of the external surface of the case.

16. The case of claim 2 wherein the photovoltaic module is expandable once removed from the case.

17. The case of claim 15 wherein the photovoltaic cell is either foldable or rollable.

18. The photovoltaic cell of claim 2 that is affixed to the case by one or more of the group consisting of suction cups, tie down straps, connectors, hook and loop fasteners, and snap fasteners.

19. The case of claim 10 wherein the electronic circuitry includes a voltage regulator integral to the case.

20. The case of claim 1 that is configured to store multiple electronic devices.

21. The case of claim 19 wherein the electronic circuitry is connectable to more than one of the multiple electronic devices.

22. The case of claim 1 wherein circuitry connects to the electronic device when the device is placed in the case.
